(19) United States
(12) Patent Application Publication
(10) Pub. No.: US 2022/0094681 A1
(43) Pub. Date: Mar. 24, 2022

(54) METHOD FOR DEVICE-DEPENDENT PROVISION OF DOWNLOAD RESOURCES

(71) Applicant: SIEMENS AKTIENGESELLSCHAFT, München (DE)

(72) Inventor: Sebastian Bode, Ahlen (DE)

(21) Appl. No.: 16/479,676

(22) PCT Filed: Nov. 14, 2017
(86) PCT No.: PCT/EP2017/079188

§ 371 Date: Jul. 22, 2019

(30) Foreign Application Priority Data
Jan. 23, 2017 (DE) 10 2017 201 021.5

(51) Int. Cl. H04L 67/00; H04L 9/32; H04L 67/60; H04L 67/303

(52) U.S. Cl. CPC H04L 63/0876; H04L 9/3247; H04L 67/34; H04L 67/303; H04L 67/32

(57) ABSTRACT

A method for a device-dependent provision of download resources provides a request of a device to a server with transfer of a proof of identity. An allocation of device properties is carried out in the server based on the proof of identity. This is followed by a collation of at least one download resource based on the device properties. This collation may occur after the receipt of the request, to tailor the selection of the downloadable resources to the individual device properties or the software installations thereof. This is followed by a configuration on the server side of at least one resource address on which the selection of download resources is provided for download. A response message is sent to the device in response to the request, where the response message contains the at least one resource address for accessing the at least one download resource.

The present patent document is a § 371 nationalization of PCT Application Serial No. PCT/EP2017/079188, filed Nov. 14, 2017, designating the United States, which is hereby incorporated by reference, and this patent document also claims the benefit of German Patent Application No. 10 2017 201 021.5, filed Jan. 23, 2017, which is also hereby incorporated by reference.

### TECHNICAL FIELD

The disclosure relates to a method for the device-dependent provision of download resources.

### BACKGROUND

In the prior art, methods are known for transferring software or software updates to devices of all kinds via an existing network connection. In the text that follows, the term “download resources” is used for software or software updates, wherein the term covers both complete or modular additions or enhancements of the software as well as software updates, firmware updates, or updates of an operating system software of the device.

In the light of the diversity in the technical designs of the devices themselves or their software installations, it has proved advantageous to provide download resources in the form of software packages which are available for download from either software package sources or package repositories as required. However, even this package-based approach is subject to limitations if a large number of individual variants of software installations need to be maintained via a single standardized mechanism.

Also, the configuration of access rights to packet repositories may be necessary, which complicates the maintenance of the software installation. With the increasing complexity of the software, the formation of groups of devices which have the same access rights to package repositories becomes more difficult.

These problems are further compounded by the fact that the user who wishes to install the software updates may not have the appropriate privileges to connect the devices to the network.

U.S. Patent Application Publication No. 2013/0185563 A1 discloses a method for device-dependent provision of download resources. In this method a request from a client device is received by an update server, the request including a proof of identity of the client device. Based on the proof of identity the update server performs an allocation of device properties. Based on the device properties the update server compiles a downloadable resource. A resource address to download the download resource is transmitted to the client device in a manifest. Based on the resource address contained in the manifest, the client device may load the downloadable resource from a payload server.

U.S. Patent Application Publication No. 2007/0169093 A1 discloses the use of a proof of identity of a mobile device to look up device functions in a database and provide a firmware update package for a download.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The object of the present disclosure is to provide a method for providing download resources, which supports a device-dependent collation of resources, (e.g., one which is individually tailored to the device properties or its software installations).

In accordance with the method, a device-specific provision of downloadable resources is provided having the following acts: (a) The device sends a request to a computer isolated by a network connection, (e.g., a server), wherein the request includes a proof of identity of the device; (b) An allocation of device properties is carried out in the server based on the proof of identity. This is followed by a collation of at least one, (e.g., a plurality of), download resources based on the device properties. This collation may be carried out after the receipt of the request, (e.g., “on demand”), to tailor the selection of downloadable resources to the individual device properties or its software installations. This is followed by a configuration on the server side of at least one, (e.g., a plurality of), resource address or Uniform Resource Locator (URL), on which the selection of the downloadable resources is provided for download; (c) A response message is sent to the device in response to the request, which response message contains the at least one resource address as a reference for accessing the at least one download resource; (d) A download request containing the proof of identity is received on the at least one resource address by the device; and (e) The at least one download resource assigned to the at least one resource address is transmitted to the device.

In contrast to known methods, the method disclosed herein does not provide any public provision of the download resources. The method requires a request by the device including specification of a proof of identity, wherein after checking the proof of identity and related privileges, individual resource addresses for access to the download resources are communicated by the server. This procedure advantageously allows a server-side control of access to the download resources, through which, for example, access permissions to the downloadable resources may be withdrawn without the involvement of the device.

In order to exclude unauthorized requests, a proof of identity is required. In the simplest case, the proof of identity is an identification number or serial number known to the server and on the part of the device. The security measure that a proof of identity of the device is required in the course of the request for access to download resources may be extended by security measures in accordance with advantageous extensions of the disclosure.

Another advantage of the method lies in the fact that on the device side a uniform configuration for access to download resources is possible. With the exception of a device-specific individual proof of identity or a few cryptographic parameters, other configuration parameters, (e.g., a server address for acknowledging the request, etc.), of different devices are identical.

The object is also achieved by a computer system for device-dependent provision of download resources, as well as by a computer program product for processing the method. The computer program is processed in a processor, which executes the processing of the method.

In order to exclude unauthorized requests, in accordance with one example, it is provided that the request by the device associated with a proof of identity is signed, thus the Uniform Resource Locator (URL) used to make the request is signed by the device. The signature of the requesting URL is an encrypted representation of the URL itself and is transmitted to the server along with the URL as an integral part of it.

For this purpose, a feature is included in the URL, the absence or modification of which clearly alerts the recipient of the URL, (e.g., the server), to the fact that the URL cannot be assigned to a known device or else no longer corresponds to the original.

To this end, the URL of such a signed request contains, for example, a cryptographic hash value. The cryptographic hash value is also referred to as a message authentication code, which in the professional world is also known as a MAC for short.

The message authentication code is formed using a symmetric secret key or an asymmetric key pair. In accordance with one example, a proof of identity, (e.g., in the form of an identification number), of the device is used as the symmetric key, which is also stored on the server.

The server may decrypt this signature and compare the signature with the transferred URL. Only if the transferred URL matches the signature does the server implement the request. If an unauthorized device were to modify plain-text parts of the URL, the signature will no longer match the URL. The server would deny such a request using the modified URL. The URL of the request optionally or additionally contains a digital certificate. In this case, the request is only valid if the request contains a valid certificate or a reference to a valid certificate.

In accordance with a further alternative example, the request is made by receiving a not necessarily signed URL via a URL reserved for the device. This means that each device is assigned an individual URL to which the respective device submits the request. The knowledge of this individual URL is used to provide an alternative proof of identity. Although this design is less secure than the design outlined above, it requires less computing power to perform cryptographic operations on the part of the server and on the part of the device, which may be resource-limited anyway.

Although after a device-side reception of the response message, which contains the at least one resource address for access to the at least one download resource, the additional download may be carried out with standard technical resources used in the field by retrieving the download resources at the now known resource addresses, but the download may also be additionally secured in accordance with the embodiments of the disclosure described in the following.

In accordance with an advantageous extension, a receipt of a download request sent by the device is provided by a second server designated by the resource address, wherein the download request includes the proof of identity. After checking the proof of identity, the at least one download resource assigned to the at least one resource address is transferred to the device.

The collation of at least one download resource to be performed by the first server based on the device properties and configuration of at least one resource address for downloading the at least one download resource are carried out in this example by involving the second server.

The second server designated by the resource address does not necessarily match the first server which received the request. For the purposes of load balancing, it is advantageous to separate the task of the first server, (e.g., the allocation of device properties, collation of downloadable resources and configuration of the resource address), from those of the second server, which acts as a file server. Should this requirement for load balancing in the network design be of lesser importance than an increased complexity in the maintenance of two servers, the tasks of the first and second server may also be performed by a single first server.

As part of a distribution of tasks over multiple servers in the course of the load balancing it is also advantageous to provide a plurality of second servers, in order to achieve a load balancing when downloading different download resources from multiple second servers. In networking technology, this may be readily implemented because the resource address or URL also includes the server address and may thus address any servers arranged in the network.

### BRIEF DESCRIPTION OF THE DRAWINGS

In the following, exemplary embodiments and advantages of the disclosure are explained in more detail by reference to the drawing.

FIG. 1 depicts a chronological sequence diagram with a schematic representation of an exchange of control messages between a device CL, a first server S1, and a second server S2.

### DETAILED DESCRIPTION

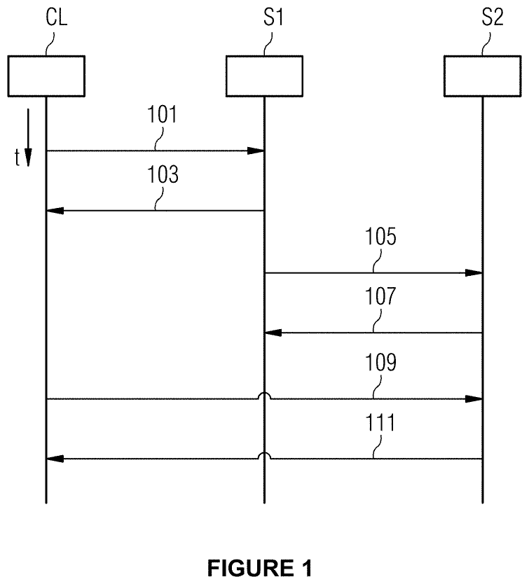

In FIG. 1, the device CL and the servers S1, S2 share a common wireless or wired network connection—not shown—which is at least temporarily configured, via which the control messages 101,103,105,107,109,111 explained in the following are exchanged.

Vertical timelines are assigned to the device CL, the first server S1, and the second server S2 in this sequence. The timelines directed with a direction arrow t run from top to bottom, so that later time points are further down than earlier time points.

The method starts with the receipt of a request 101 of the device CL on the first server S1. The request 101 contains a proof of identity of the device. In one case, the proof of identity is an identification number or serial number known to the first server S1 and to the device CL. The first server S1 forwards this identification number to the second server S2 on request, to enable authorization of the device CL by the second server S2 in the further course of the method.

The first server S1 performs an allocation of device properties based on the proof of identity. This should be understood to mean that in the first server, based on the proof of identity of the device, data are stored which represent a device type and a current installation state of the device CL, and a requirement for download resources is derived based on the stored data.

The simple security measure, whereby for access to download resources a proof of identity of the device is required in the course of the request, which may be compared with a proof of identity stored in the first server S1, is extended by advantageous security measures. To this end, it is provided that the request 101 by the device CL associated with a proof of identity is signed, which means the Uniform Resource Locator (URL) used for the request 101 is signed by the device CL. The signature of the requesting URL is an encrypted representation of the URL itself and is transmitted to the server S1 along with the URL as an integral part of it.

The URL of the signed request 101 in the present exemplary embodiment contains a cryptographic hash value. The cryptographic hash value, or Message Authentication Code or MAC, may be formed in accordance with one of the following methods:
CBC-MAC using a known block cipher (e.g., DES, 3DES, AES, IDEA);
HMAC using a known hash function (e.g., MD5, SHA-1, RIPEMD, RIPEMD160), which are also known as HMAC-MDS, HMAC-SHA1, HMAC-RIPEMD, HMAC-RIPEMD160;
HMAC using a known hash function with abbreviated output (e.g., HMAC-MD5-80, HMAC-SHA1-80, HMAC-RIPEMD-80, HMACRIPEMD160-80 with 80-bit shortened output);
MAA;
RIPE-MAC; and/or
MD5-MAC.

The message authentication code is formed using a symmetric secret key or an asymmetric key pair. As a symmetric key, for example, the proof of identity (e.g., in the form of a serial number or identification number), of the device CL is used, which is also stored on the server S1.

The server S1 may decrypt and verify this signature and compare the signature with the transferred URL. Only if the transferred URL of the request 101 matches the signature does the server S1 implement the request. The URL of the request, optionally or additionally, contains a digital certificate. In this case, the request is only valid if the request contains a valid certificate or a reference to a valid certificate.

For the exemplary embodiment of a separation of the first server S1 and the second server S2 shown in FIG. 1, the collation of the download resources by the first server S1 is carried out in coordination with the second server S2 in the form of one or more request messages 105 sent by the first server S1 to the second server S2 and the one or more confirmation messages 107 in response to the request messages 105, which are sent by the second S2 server to the first server S1. In FIG. 1, these request messages 105 and request messages 107 are drawn temporally after the request 101 and a response message 103 answering the request to the device CL. This temporal specification, however, is only intended as an example. Instead, the exchange of the request messages 105 and the confirmation messages 107 may also take place in close temporal proximity after receipt of the request 101, as well as before or temporally overlapping, either during or after the transmission of the response message 103.

In addition, at least one resource address on the second server S2 for downloading the at least one download resource is configured by the first server S1. This configuration of the resource address by the first server S1 also takes place in coordination with the second server S2 in the form of one or more request messages 105 sent by the first server S1 to the second server S2 and the one or more confirmation messages 107 answering the request messages 105.

The server S1 now accesses a database—not shown—to compile a collection of at least one download resource, (e.g., a plurality of download resources), based on the device properties. This collation may be carried out after the arrival of the request and is specifically tailored to the device properties on the basis of the proof of identity, in order to match the selection of downloadable resources individually to the properties of the device CL or its individual software installation. This is followed by a configuration on the server side of at least one resource address or URL, (e.g., a plurality of resource addresses or URLs), on which the selection of the downloadable resources is provided for download. In the present exemplary embodiment, these resource addresses are configured on the second server S2 in coordination with the first server and with the involvement of the request messages 105 described above and the confirmation messages 107.

The first server S1 then sends a response message 103 in response to the request 101 to the device CL, wherein the response message 103 contains the at least one resource address for access to the at least one download resource.

Finally, the device CL sends a download request 109 to one of the resource addresses of the second server S2 that were previously communicated. The download request 109 received on the second server S2 also contains a proof of identity of the device CL. This is followed by a transfer 111 of the download resource assigned to this resource address to the device CL.

The download request 109 and transfer 111 are carried out multiple times sequentially or in parallel, according to the number of downloadable resources or resource addresses.

According to an alternative embodiment described in the following, it is possible to omit an exchange of request messages 105 and request messages 107 between the servers S1, S2.

This embodiment is characterized in that the configuration of the resource addresses on the second server S2 is carried out by the first server S1 via a modified response message 103, which the device CL receives and processes. After processing the modified response message 103 in the device CL, the latter sends a modified download request 109 to the second server S2, which message transfers an authorization for the download request 109. The modified response message sent by the first server S1 103 contains, in a so-called query part of the URL which is used for the transmission of the response message 103, information to authorize the device CL, which is forwarded from the device CL to the second server S2 in the form of the modified download request 109. The second server S2 then checks the authorization of the device CL based on the URL transferred for the modified download request 109.

In this embodiment, therefore, the direct coordination using request messages 105 and confirmation messages 107 between the first and the second server S1, S2 is eliminated, which means a load reduction, in particular, if the second server S2 is designed in the form of a server farm, or so-called Content Delivery Network.

The measures for additional security outlined above for the request 101, namely signing the message or transfer of a certificate in the URL are also applicable to the modified response message 103 as well as to the modified download request 109.

In addition, in accordance with another embodiment, it is provided that in addition to the authorization, a temporal validity of the authorization, (a type of the authorization, etc.), is also transmitted. These items of information mentioned may be transferred together with the signature in the query part of the URL of the modified response message 103 and of the modified download request 109.

The exemplary embodiment of a separation of the first server S1 and the second server S2 shown in FIG. 1 may also be replaced by an alternative exemplary embodiment—not shown—in which the device CL communicates only with the first server S1 by omitting the second server S2, in which case the request messages 105 and the confirmation messages 107 should then be understood as internal control messages within the first server S1. The first server S1 then assumes all tasks of the two servers S1, S2 shown in FIG. 1, namely the allocation of device properties, collation of downloadable resources, configuration of the resource addresses, and acts as a file server.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for device-dependent provision of download resources, the method comprising:
receiving a request comprising a proof of identity from a device;
allocating device properties based on the proof of identity, collating at least one download resource based on the device properties, and configuring at least one resource address to download the at least one download resource;
sending a response message in answer to the request to the device, wherein the response message contains the at least one resource address for access to the at least one download resource;
receiving a download request containing the proof of identity on the at least one resource address by the device; and
transferring the at least one download resource assigned to the at least one resource address to the device.

2. The method of claim 1, wherein the proof of identity is provided by a signed request from the device.

3. The method of claim 1, wherein the proof of identity is provided by receipt of the request via a Uniform Resource Locator reserved for the device.

4. (canceled)

5. The method of claim 1, wherein the receiving of the request, the allocating, and the sending are carried out on a first server and the receiving of the download request and the transferring are carried out on at least one second server.

6. A computer system for device-dependent provision of download resources, the system comprising:
an interface for receiving a request comprising a proof of identity from a device;
an interface for allocating device properties based on the proof of identity, collating at least one download resource based on the device properties, and configuring at least one resource address to download the at least one download resource;
an interface for sending a response message in response to the request to the device, wherein the response message contains the at least one resource address for access to the at least one download resource;
an interface for receiving a download request containing the proof of identity on the at least one resource address by the device; and
an interface for transferring the at least one download resource assigned to the at least one resource address to the device.

7. (canceled)

8. A computer program product comprising computer code, wherein when executed on at least one server, is configured to cause the at least one server to:
receive a request comprising a proof of identity from a device;
allocate device properties based on the proof of identity, collate at least one download resource based on the device properties, and configure at least one resource address to download the at least one download resource;
send a response message in answer to the request to the device, wherein the response message contains the at least one resource address for access to the at least one download resource;
receive a download request containing the proof of identity on the at least one resource address by the device; and
transfer the at least one download resource assigned to the at least one resource address to the device.

9. The system of claim 6, wherein the proof of identity is provided by a signed request from the device.

10. The system of claim 6, wherein the proof of identity is provided by receipt of the request via a Uniform Resource Locator reserved for the device.

11. The system of claim 6, further comprising:
a first server configured to receive the request, allocate the device properties, collate the at least one download resource, configure the at least one resource address, and send the response message; and
a second server configured to receive the download request and transfer the at least one download resource.
